(19) United States
(12) Patent Application Publication
(10) Pub. No.: US 2005/0289277 A1
(43) Pub. Date: Dec. 29, 2005

(54) Data processing on extended mobile access enabled computer

(76) Inventors: Riley W. Jackson, Portland, OR (US); Brian V. Belmont, West Linn, OR (US); Richard A. Forand, Portland, OR (US); James P. Kardach, Saratoga, CA (US); Jeffrey L. Huckins, Chandler, AZ (US)

Correspondence Address: INTEL CORPORATION, P.O. BOX 5326, SANTA CLARA, CA, 95056-5326, US

(21) Appl. No.: 10/881,304

(22) Filed: Jun. 29, 2004

(51) Int. Cl. G06F 9/455

(52) U.S. Cl. 710/306; 709/250; 703/25

(57) ABSTRACT

Embodiments of the present invention can make data from a primary system of a computer available to an extended mobile access module embedded in the computer.

### FIELD OF THE INVENTION

The present invention relates to the field of computing. More specifically, the present invention relates to processing data on a computer having extended mobile access capabilities.

### BACKGROUND

Computers can take an annoyingly long time to boot up—several minutes is not uncommon. So, even when users are not actively using their computers, they often prefer to leave their computers running so they don't have to wait for their machines to boot up every time they want to check email, look at their calendar, or use a variety of other functions, services, and amenities that computers often provide on an on-going basis or in the background.

Listening to music is a good example of the type of amenity to which many users would like to have ready access. With the increased popularity of MP3 (Moving Picture Experts Group, Audio Layer III) and other digital audio formats, computers are often a user's primary device for downloading, managing, and playing audio files. Playing music on a computer, however, usually requires that the computer be in a fully active state. When a computer is in an active state, it can consume a relatively large amount of power and generate a relatively large amount of heat.

Power consumption and heat generation can be especially problematic for mobile computing. For example, a user may like to carry his notebook computer with him throughout the day to have ready access to his music, but playing MP3 files on a notebook computer may consume 10 to 14 watts of power. At that rate, the batteries in a typical notebook computer may only last 3 or 4 hours. And, due to the large amount heat, a user may not be able to carry his computer in a carrying case or bag. This is because a carrying case or bag usually does not permit sufficient air flow around a computer. With the lack of airflow, a fully active computer may overheat and break down in a fairly short period of time.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of an extended mobile access enabled computer.

FIG. 2 illustrates a block diagram of one embodiment of an extended mobile access enable computer.

FIG. 3 illustrates one embodiment of a user interface display.

FIG. 4 illustrates one embodiment of the present invention from the perspective of a primary system.

FIG. 5 illustrates another embodiment of the present invention from the perspective of a primary system.

FIG. 6 illustrates yet another embodiment of the present invention from the perspective of a primary system.

FIG. 7 illustrates one embodiment of the present invention from the perspective of an extended mobile access module.

FIG. 8 illustrates another embodiment of the present invention from the perspective of an extended mobile access module.

FIG. 9 illustrates one embodiment of hardware system that can perform various functions of the present invention.

FIG. 10 illustrates one embodiment of a machine readable medium to store instructions that can implement various functions of the present invention.

### DETAILED DESCRIPTION OF THE INVENTION

In the following description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. It is well understood by those skilled in the art that these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

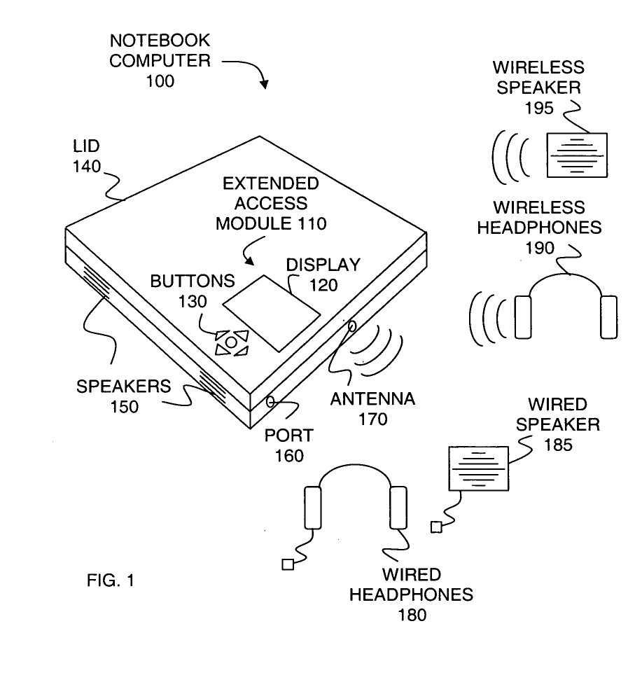

Embodiments of the present invention can make data from a primary system of a computer available to an extended mobile access module embedded in the computer. FIG. 1 illustrates one embodiment of a notebook computer 100 which can include embodiments of the present invention. Notebook computer 100 includes extended mobile access module 110. Extended mobile access module 110 has its own user interface, including a display 120 and navigation buttons 130. This user interface can be accessed even when lid 140 of notebook 100 is closed. Moreover, the extended mobile access module 110 can be a discrete system from the primary operating system of notebook 100 so that module 110 can be used even when the primary operating system of notebook 100 is in a non-active state, such as a suspend mode or a sleep state. In other words, even when the computer is essentially turned off, the computer can still provide utility and functionality through extended mobile access module 110.

An extended mobile access module can include any of a variety of components. In many cases, the modules are built around low power, low heat processors or controllers, such as those commonly used in cellular phones and personal data assistants (PDAs). For example, an ARM (Advanced RISC Machine) processor could be used, such as an Xscale processor available from Intel Corporation of Santa Clara, Calif.

A module using a low power processor can consume a great deal less energy than the primary system of many mobile computers. For example, whereas a typical primary system may consume 10 to 14 watts while playing MP3 audio, and exhaust a fully charged battery pack in three or four hours, an extended mobile access module may consume just 300 milliwatts to play the same MP3 audio, providing almost 40 times the battery life. Furthermore, the heat generated by many of these processors is often so low that they can operate with little or no surrounding air flow. In other words, an extended mobile access module may be fully active without overheating, even while the computer is in a carrying case or bag.

In addition to a. processor or controller, an extended mobile access module may include, or have access to, any of a variety of other devices and components. For example, module 110 could share built-in speakers 150, port 160, and/or antenna 170 with the primary system. Through port 160 or antenna 170, the module may be able to send signals to any number of devices, such as wired headphones 180, wired speaker 185, wireless headphones 190, and wireless speaker 195. Similarly, port 160 or antenna 170 could be used to receive input from any of a variety of devices, such as a mouse or trackball. Alternately, the module could include dedicated devices and components, such as its own flash memory. In alternate embodiments, the user interface could include a touch screen rather than, or in addition to, display 120 and navigation buttons 130. The user interface could also include a number pad, track ball, stylus, and the like.

An extended mobile access module can also be embedded in a wide variety of computers, including various notebook designs as well as desktop and tablet computers. In a desktop computer, for instance, the extended mobile access module could be embedded in a keyboard. In a tablet computer, the user interface components could be used for both the primary system and the extended mobile access module. For example, the primary system may use the entire tablet screen, and the extended mobile access module may use just a portion of the screen.

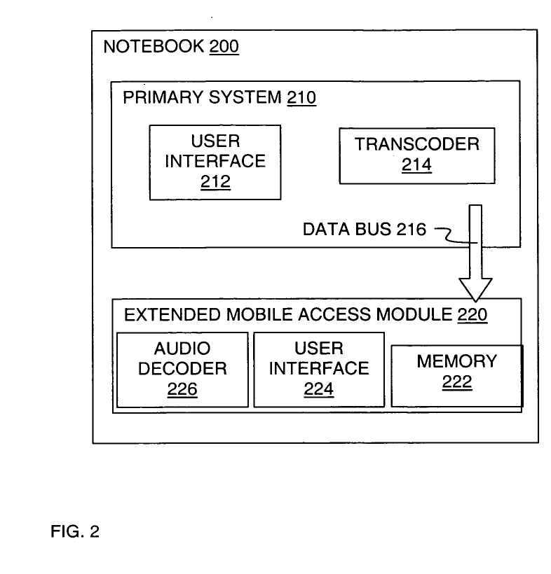

The type of data made available to an extended mobile access module by embodiments of the present invention may depend on the number and type of functions that the extended mobile access module can provide. The module could be designed for a single, specific function. For example, the module could be a built-in MP3 player. In which case, embodiments of the present invention could provide audio files from the primary system in the appropriate format for the MP3 player. Or, the device could provide multiple functions, such as audio playback, calendar tools, an address book, wireless email, paging, cellular telephone, game play, etc. In which case, embodiments of the present invention could provide the appropriate data in the appropriate format for one or more of these functions. FIGS. 2 through 8 illustrate a number of examples of these and other situations.

FIG. 2 illustrates a block diagram of one embodiment of a notebook computer 200 according to the present invention. Notebook computer 200 includes a primary system 210 and an extended mobile access module 220. The extended mobile access module 220 may be designed for a single function, such as playing audio files of a particular format, such as MP3 files. The primary system, however, can be used to download, store, and otherwise manage a large number of audio files in any of a variety of formats, such as MP3, WMA (Windows Media Audio), and the like.

In which case, prior to placing the primary system into a non-active state, a user can browse the audio files on primary system 210 with user interface 212 and select which files he or she wants to make available for extended mobile access. If one or more of the selected files are not in the data format supported by the extended mobile access module, transcoder 214 can be used to preprocess those files into the supported format prior to transferring the files over data bus 216 to memory 222 of module 220. By preprocessing the data using the primary system, module 220 does not need as much processing power as it otherwise would, allowing module 220 to be simpler and less expensive.

Once the files are loaded into the extended mobile access system's memory 222, primary system 210 can enter a non-active state, if desired. The module's user interface 224 can be updated to list of files in memory 222. The data can be arranged in any number of ways, and user interface 224 can provide access to the data in any number of ways. If a user selects a file, audio decoder 226 can decode the audio signal from the file.

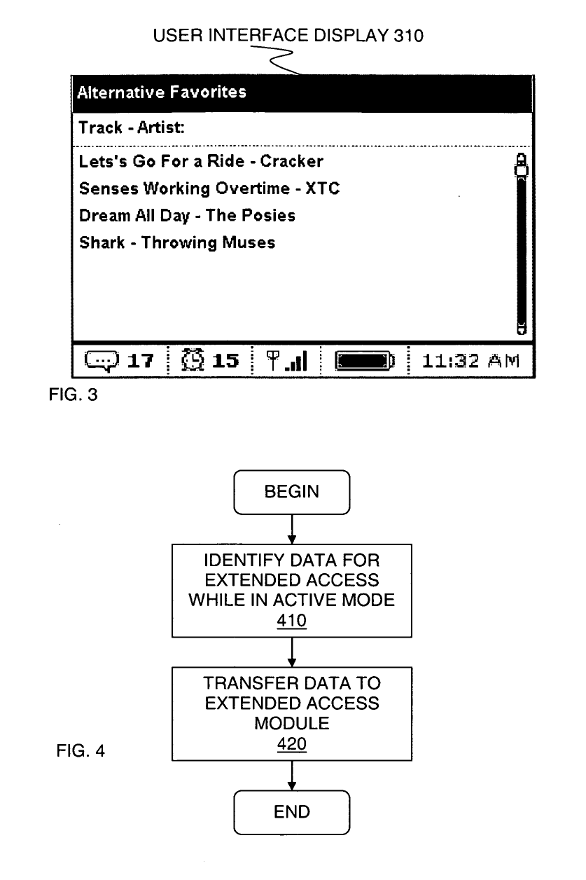

FIG. 3 illustrates one embodiment of a user interface display 310 that could be provided by user interface 224 of FIG. 2. In the illustrated embodiment, the audio files are organized into a hierarchy under different types of music. The hierarchy could be created on the primary system. In which case, in addition to the audio files themselves, additional data records could be included to define where in the hierarchy each file belongs.

FIG. 4 demonstrates one embodiment of the present invention at a high level from the perspective of a primary system. At 410, the process identifies data for extended mobile access while the primary system is in the active mode. At 420, the process transfers the data to the extended mobile access module.

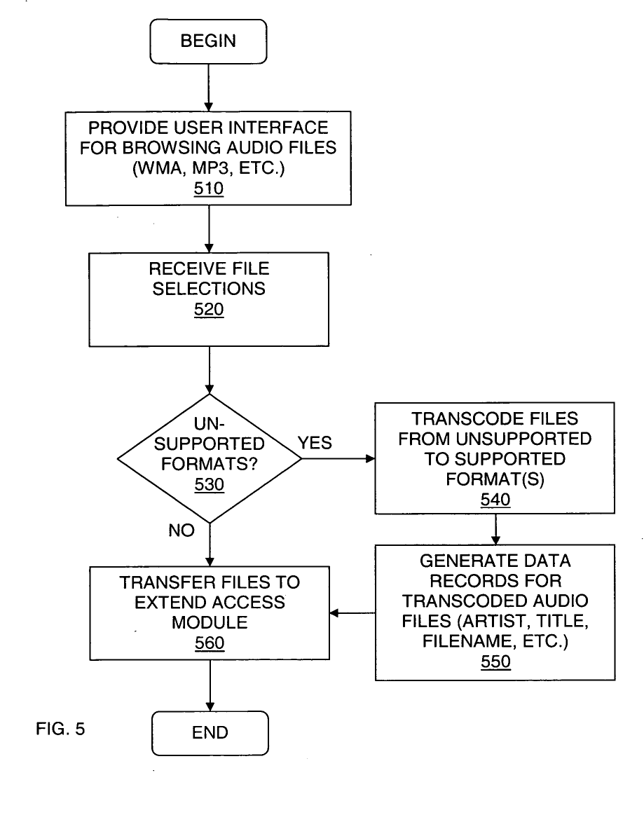

FIG. 5 demonstrates a more detailed embodiment of the present invention from the perspective of a primary system. At 510, the process provides a user interface for browsing audio files, such as WMA, MP3, etc. At 520, the process receives file selections through the user interface. If any of the selected files are not supported by the extended mobile access module at 530, the process transcodes files from the unsupported format(s) to the supported format(s) at 540. Then, for the files that were transcoded, the process generates data records for each file to provide identifying information for the file to the extended mobile access module at 550. For example, the data files can indicate the artist, song title, filename, hierarchical position, etc. for each transcoded file. Transcoding and data record generation can be performed in any number of ways.

All of the supported files, transcoded files, and data files are transferred to the extended mobile access module at 560. If, back at 530, all of the selected files were supported by the extended mobile access module, it may be possible to skip the transcoding and data record generation and go straight to transferring the files at 560.

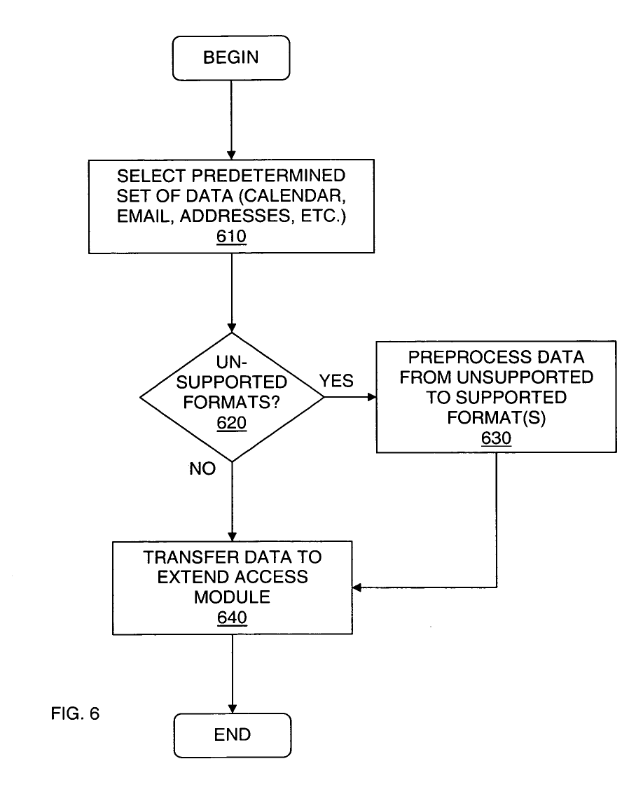

FIG. 6 demonstrates yet another embodiment of the present invention from the perspective of a primary system, but this time involving PIM (personal information management) data. At 610, the process selects a predetermined set of data for extended mobile access. For example, the data could include calendar data from a particular window of time, email data from a particular window of time or a particular subset of email (the inbox, for example), a particular subset of address data (personal contacts, for example), and the like. Any number of criteria can be used to define a predetermined set of data to transfer. The selection process can also be launched automatically when, for instance, the primary system is about to enter a non-active state.

If, at 620, any of the selected data is in a format that is not supported by the extended mobile access module, the process can preprocess the data from the unsupported format(s) to the supported format(s) at 630. That is, in order to keep the extended mobile access module simple and inexpensive, it may be designed or licensed to use only certain formats of data. On the primary system, however, a user may use a wide variety of data formats. Any number of approaches can be used to preprocess the data into supported formats. For example, the address book data on the primary system may be HTML and the extended mobile access may not be capable of rendering it. In this case the only the simple text that makes up the address book entry information would be sent to the extended mobile access module. Once the data has been preprocessed at 630, or if no data is in an unsupported state at 620, the process can transfer the data to the extended mobile access module at 640.

Alternate embodiments can combine the processes of FIGS. 5 and 6. For example, some types of data can be manually selected through a user interface, and other types of data can be automatically selected based on predetermined criteria.

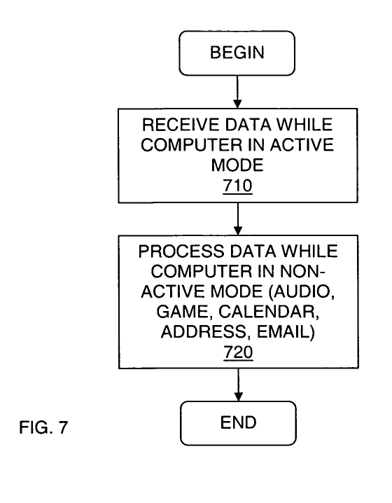

FIG. 7 demonstrates one embodiment of the present invention at a high level from the perspective of an extended mobile access module. At 710, the module receives data from a primary system while the computer is in an active mode. Then, at 720, the module processes the data, which can be done while the computer is in a non-active mode. Processing the data could include any number of functions or services, including audio playback, gaming, calendar access, address book access, email, etc.

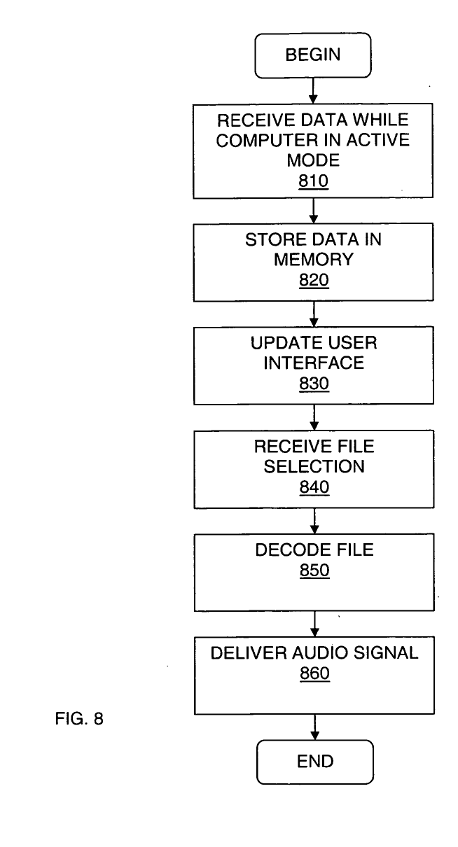

FIG. 8 demonstrates another embodiment of the present invention from the perspective of an extended mobile access module. At 810, the module receives data from a primary system while the computer is in an active mode of operation. At 820, the module stores the data in local memory. For example, the module may include any number of memory devices to store the data, including flash memory, RAM (random access memory), etc. At 830, the module updates a user interface with the data. For example, with audio data, the module may update a number of play lists with newly stored songs, and possibly organize the list of songs into a hierarchical structure. At 840, the module receives a file selection through the user interface. At 850, the module decodes the file. In the case of audio data, the module delivers an audio signal based on the decoded data at 860. The audio signal could be played, for instance, over speakers built into the computer, through a wired audio port to headphones or speaker, or through a wireless connection to headphones or speaker.

FIGS. 1-8 illustrate a number of implementation specific details. Other embodiments may not include all the illustrated elements, may arrange the elements differently, may combine one or more of the elements, may include additional elements, and the like.

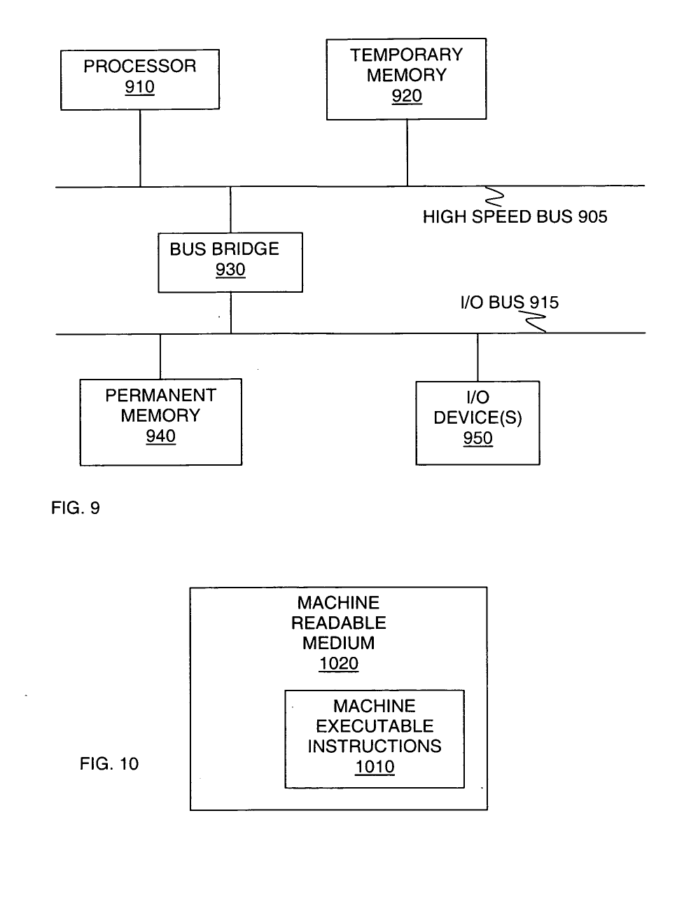

FIG. 9 illustrates one embodiment of a generic hardware system intended to represent a broad category of systems that could be used for either a primary system or an extended mobile access module in a computer. In the illustrated embodiment, the hardware system includes processor 910 coupled to high speed bus 905, which is coupled to input/output (I/O) bus 915 through bus bridge 930. Temporary memory 920 is coupled to bus 905. Permanent memory 940 is coupled to bus 915. I/O device(s) 950 is also coupled to bus 915. I/O device(s) 950 may include a display device, a keyboard, one or more external network interfaces, etc.

Certain embodiments may include additional components, may not require all of the above components, or may combine one or more components. For instance, temporary memory 920 may be on-chip with processor 910. Alternately, permanent memory 940 may be eliminated and temporary memory 920 may be replaced with an electrically erasable programmable read only memory (EEPROM), wherein software routines are executed in place from the EEPROM. Some implementations may employ a single bus, to which all of the components are coupled, or one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

In one embodiment, various functions of the present invention, as described above, can be implemented using one or more hardware systems such as the hardware system of FIG. 9. In one embodiment, one or more functions of the present invention may be implemented as software routines executed by one or more execution units within the hardware system(s). For a given system, the software routines can be stored on a storage device, such as permanent memory 940. Alternately, as shown in FIG. 10, the software routines can be machine executable instructions 1010 stored using any machine readable storage medium 1020, such as a hard drive, a diskette, CD-ROM, magnetic tape, digital video or versatile disk (DVD), laser disk, ROM, Flash memory, etc. The series of instructions need not be stored locally, and could be received from a remote storage device, such as a server on a network, a CD-ROM device, a floppy disk, etc., through, for instance, I/O device(s) 950 of FIG. 9.

From whatever source, the instructions may be executed by processor 910. In one implementation, these software routines are written in the C programming language. It is to be appreciated, however, that these routines may be implemented in any of a wide variety of programming languages.

In alternate embodiments, the functions of the present invention described above may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, one or more programmable gate arrays (PGAs) could be used to implement one or more functions of the present invention. In yet another example, a combination of hardware and software could be used to implement one or more functions of the present invention.

Thus, data processing on an extended mobile access enabled computer is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

1. A method comprising:
identifying data to be made available for extended mobile access from a computer, said data being identified using a primary system of the computer while the computer is in an active mode of operation; and
transferring the data to an extended mobile access module embedded with the computer.

2. The method of claim 1 wherein the data comprises at least one of audio data, calendar data, email data, address data, or game data.

3. The method of claim 1 wherein the data comprises at least one of WMA (Windows Media Audio) files or MP3 (Moving Picture Experts Group, Audio Layer III) files.

4. The method of claim 1 further comprising:
pre-processing the data using the primary system prior to transferring the data to the extended mobile access module.

5. The method of claim 4 wherein pre-processing the data comprises:
transcoding one or more portions of the data to a format supported by the extended mobile access module.

6. The method of claim 4 wherein the extended mobile access module supports a first audio data format, wherein the data comprises audio files in a plurality of audio data formats, and wherein pre-processing the data comprises:
transcoding the audio files that are not in the first data format into the first data format before transferring the transcoded audio files to the extended mobile access module.

7. The method of claim 6 wherein pre-processing the data further comprises:
generating data records for each of the transcoded audio files; and
transferring the data records with the transcoded audio files to the extended mobile access module.

8. The method of claim 1 wherein identifying the data comprises:
providing an interface for the primary system to allow a user to browse files; and
receiving one or more indications of files selected by the user through the interface.

9. The method of claim 1 wherein identifying the data comprises:
selecting a predetermined set of data.

10. The method of claim 1 wherein the predetermined set of data comprises at least one of calendar data for a particular window of time, email data for a particular window of time, a particular subset of email data, or a particular subset of address data.

11. A method comprising:
receiving data at an extended mobile access module embedded with a computer, said data being received from a primary system of the computer while the computer is in an active mode of operation; and
processing the data at the extended mobile access module while the computer is in a non-active mode of operation.

12. The method of claim 11 wherein one or more portions of the data has been transcoded by the primary system into a format supported by the extended mobile access module.

13. The method of claim 11 wherein the data includes transcoded audio files and data records for each transcoded audio file.

14. The method of claim 11 wherein processing the data comprises:
storing the data in a memory; and
updating a user interface to reflect the data.

15. The method of claim 11 wherein processing the data comprises:
providing a user interface to the data;
receiving a file selection from a user through the user interface; and
executing on the file selection.

16. The method of claim 15 wherein executing on the file selection comprises:
decoding the file selection; and
rendering the file selection.

17. The method of claim 16 wherein rendering the file selection comprises:
delivering an audio signal to at least one of a wired speaker, a wireless speaker, wired headphones, or wireless headphones.

18. The method of claim 15 wherein executing on the file selection comprises at least one of displaying a calendar item, displaying an email, displaying an address, or launching a game.

19. An apparatus comprising:
identification circuitry to identify data to be made available for extended mobile access from a computer, said data being identified while the computer is in an active mode of operation; and
transfer circuitry to transfer the data to an extended mobile access module embedded with the computer.

20. The apparatus of claim 19 further comprising:
processing circuitry to pre-process the data prior to the data being transferred to the extended mobile access module.

21. The apparatus of claim 20 wherein the processing circuitry comprises:
a transcoder to transcode one or more portions of the data to a format supported by the extended mobile access module.

22. The apparatus of claim 19 wherein identification circuitry comprises:
a user interface to allow a user to browse files and to receive one or more indications of files selected by the user through the user interface.

23. The apparatus of claim 19 wherein the transfer circuitry comprises a data bus.

24. An extended mobile access module comprising:
receive circuitry to receive data from a primary system of a computer while the computer is in an active mode of operation; and
processing circuitry to process the data while the computer is in a non-active mode of operation.

25. The extended mobile access module of claim 24 wherein one or more portions of the data is to be transcoded by the primary system into a format supported by the processing circuitry.

26. The extended mobile access module of claim 24 wherein the processing circuitry comprises:
a memory to store the data;
a user interface to allow a user to browse the data; and
a processor to execute on one or more files selected by the user through the user interface.

27. The extended mobile access module of claim 26 wherein the processor comprises:
an audio decoder.

28. A machine readable medium having stored thereon machine executable instructions that, when executed, implement a method comprising:
identifying data to be made available for extended mobile access from a computer, said data being identified using a primary system of the computer while the computer is in an active mode of operation; and
transferring the data to an extended mobile access module embedded with the computer.

29. The machine readable medium of claim 28, the method further comprising:
pre-processing the data using the primary system prior to transferring the data to the extended mobile access module.

30. The machine readable medium of claim 29 wherein pre-processing the data comprises:
transcoding one or more portions of the data to a format supported by the extended mobile access module.

31. A machine readable medium having stored thereon machine executable instructions that, when executed, implement a method comprising:
receiving data at an extended mobile access module embedded with a computer, said data being received from a primary system of the computer while the computer is in an active mode of operation; and
processing the data at the extended mobile access module while the computer is in either the active mode of operation or a non-active mode of operation.

32. The machine readable medium of claim 31 wherein one or more portions of the data has been transcoded by the primary system into a format supported by the extended mobile access module.

33. The machine readable medium of claim 31 wherein processing the data comprises:
storing the data in a memory;
updating a user interface to reflect the data.
receiving a file selection from a user through the user interface; and
executing on the file selection.

34. A system comprising:
a notebook computer;
a primary system of the notebook computer; and
an extended mobile access module embedded with the computer, said primary system to identify data to be made available for extended mobile access from the computer and to transfer the data to the extended mobile access module while the computer is in an active mode of operation, said extended mobile access module to receive the data and to process the data while the computer is in a non-active mode of operation.

35. The system of claim 34 wherein the primary system is further to pre-process the data prior to transferring the data to the extended mobile access module.

36. The system of claim 34 wherein the primary system is further to transcode one or more portions of the data to a format supported by the extended mobile access module prior to transferring the data to the extended mobile access module.
